(19) United States
(12) Patent Application Publication
(10) Pub. No.: US 2005/0114064 A1
(43) Pub. Date: May 26, 2005

(54) Circuit for a parallel bit test of a semiconductor memory device and method thereof

(76) Inventors: Joo-weon Shin, Suwon-si (KR); Byung-chul Kim, Suwon-si (KR); Seung-bum Ko, Hwaseong-si (KR); Soo-in Cho, Seoul (KR)

Correspondence Address: HARNESS, DICKEY & PIERCE, P.L.C., P.O. BOX 8910, RESTON, VA, 20195, US

(21) Appl. No.: 10/911,503

(22) Filed: Aug. 5, 2004

(30) Foreign Application Priority Data
Nov. 11, 2003 (KR) 2003-0079387

(51) Int. Cl. G01D 3/00

(52) U.S. Cl. 702/117

(57) ABSTRACT

A method for performing a parallel bit test of a semiconductor memory device, including writing data to each of a plurality of memory cells, reading data from each of the plurality of memory cells, testing the data from each of the plurality of memory cells in a first test mode, and testing the data from each of the plurality of memory cells in a second test mode. A circuit including a first test mode circuit for receiving first data, a second test mode circuit for receiving second data, and wherein the first test mode circuit tests the received first data and the second test mode tests the received second data. Another circuit including a first comparator with a plurality of comparison circuits, a test mode selector for selecting at least one of a plurality of outputs from the first comparator, and a second comparator for receiving the selected output.

### BACKGROUND OF THE INVENTION

This application claims the priority of Korean Patent Application No. 10-2003-0079387 filed on Nov. 11, 2003 in the Korean Intellectual Property Office, the disclosure of which is incorporated herein by reference in its entirety.

1. Field of the Invention

The present invention relates generally to a semiconductor memory device, and more particularly to a circuit for a parallel bit test of a semiconductor memory device and method thereof.

2. Description of the Related Art

Following the fabrication of a semiconductor memory device, the semiconductor memory device may be analyzed. One way in which a semiconductor memory device may be analyzed is with a semiconductor memory device test, wherein various characteristics of the semiconductor memory device may be evaluated.

A semiconductor memory device test may determine whether the semiconductor memory device meets a standard for the semiconductor device. The semiconductor device test may be applied at a wafer level and/or a package level. The semiconductor memory device test may determine the numbers of semiconductor memory devices that meet the standard for the semiconductor memory device. When the semiconductor memory device is determined to not meet the standard for the semiconductor memory device, failure analysis may be performed in order to determine the causes of the failure of the failed semiconductor memory device.

One way for performing the semiconductor memory device test may be to perform a function test, wherein write and/or read operations of the semiconductor memory device may be evaluated under actual operating conditions of the semiconductor memory device. In the function test, test pattern data may be written to a plurality of memory cells of the semiconductor memory device, and data may be read from the plurality of memory cells. The read data may then be compared with the test pattern data. This comparison may determine whether data in a memory cell is inverted, after write and/or read operations are executed. The causes of the data inversion may include a fabrication failure. An example of a fabrication failure may be coupling between adjacent memory cells, a parasitic current path (i.e., a bridge), poor electrical connections, and/or other relevant causes of fabrication failure. Specifically, the comparison may determine whether test data written at a high logic level to a memory cell is inverted to data at a low level when it is read and/or whether test data written at a low logic level to a memory cell is inverted to data at a high level when it is read.

As semiconductor memory devices are fabricated with higher densities, additional time may be required to execute a semiconductor memory device test. Increased time for the semiconductor memory device test may delay and/or add cost to the production of the semiconductor memory devices. For example, assuming that the number of memory cells of a semiconductor memory device being tested is N, and the number of data input/output (I/O) terminals is M, then N/M data read and/or write operations may be necessary in order to access all of the memory cells of the semiconductor memory device. However, in this example, if the data read and/or write operations are performed simultaneously for the N memory cells through each of the M I/O terminals, all of the N memory cells may be accessed by performing N/(M*N) data read and/or write operations, which reduces to 1/N. With this method, the test time may be reduced to 1/N. This method may be referred to as a parallel bit test (PBT) or a multi bit test (MBT).

FIG. 1 illustrates a circuit diagram of a parallel bit test circuit for a semiconductor memory device by conventional methods. As shown, the parallel bit test circuit may include two exclusive NOR gates 1 and 2 and an AND gate 3.

The semiconductor memory device may have test data written to four memory cells. A data read operation may be performed on each of the four memory cells in order to read the test data. As shown in FIG. 1, the exclusive NOR gates 1 and 2 may receive data signals FD00, FD01, FD02 and FD03 from the four memory cells in pairs. The AND gate 3 may receive output signals from the exclusive NOR gates 1 and 2 and output a test output signal TM. The test data signals FD00, FD01, FD02 and FD03 may be compared with the test output signal TM.

In an example of the conventional method, four data signals FD00, FD01, FD02 and FD03 may have logic levels low, high, low and high, respectively, and may be written to four memory cells. It may be determined from data read operations that the four memory cells contain logic low, high, low, and low, respectively. This inconsistency between the data signals FD00, FD01, FD02 and FD03 and the logic levels read from the four memory cells may be due to a failure of at least one of the four memory cells.

In another example of the conventional method, the four data signals FD00, FD01, FD02 and FD03 may have logic levels low, high, low, and high, respectively. The data signals FD00, FD01, FD02 and FD03 may be input in pairs to the exclusive NOR gates 1 and 2 as illustrated in FIG. 1. The AND gate 3 may receive the outputs of the NOR gates 1 and 2 as inputs and then output a test output signal TM with a low level. It may be assumed for this example that the four data signals FD00, FD01, FD02 and FD03 have logic levels low, high, low, and low, respectively, and may be read from the four memory cells. The data signals FD00, FD01, FD02 and FD03 may then be input in pairs to the exclusive NOR gates 1 and 2. The AND gate 3 may output a test output signal TM with a low logic level. In both cases, the logic level of the test output signal TM may be the same, as shown above. Since both cases output the same logic level output signal TM, no determination may be made as to whether data inversion occurred.

### SUMMARY OF THE INVENTION

An exemplary embodiment of the present invention is a method for performing a parallel bit test of a semiconductor memory device, including writing data to each of a plurality of memory cells, reading data from each of the plurality of memory cells, testing the data from each of the plurality of memory cells in a first test mode, and testing the data from each of the plurality of memory cells in a second test mode.

Another exemplary embodiment of the present invention is a circuit, including a first test mode circuit for receiving first data, a second test mode circuit for receiving second data, and wherein the first test mode circuit tests the received first data and the second test mode tests the received second data.

Another exemplary embodiment of the present invention is a circuit, including a first comparator including a plurality of comparison circuits, a test mode selector for selecting at least one of a plurality of outputs from the first comparator, and a second comparator for receiving the selected output.

### BRIEF DESCRIPTION OF THE DRAWINGS

The above and other features and advantages of the present invention will become more apparent by describing in detail example embodiments thereof with reference to the attached drawings in which:

FIG. 1 is a circuit diagram of a conventional parallel bit test circuit for a semiconductor memory device;

FIG. 2 is a flowchart of a parallel bit test method of a semiconductor memory device according to an example embodiment of the present invention;

FIG. 3 is a block diagram of a parallel bit test circuit of a semiconductor memory device according to an example embodiment of the present invention; and

FIG. 4 is a circuit diagram showing an example embodiment of the parallel bit test circuit shown in FIG. 3.

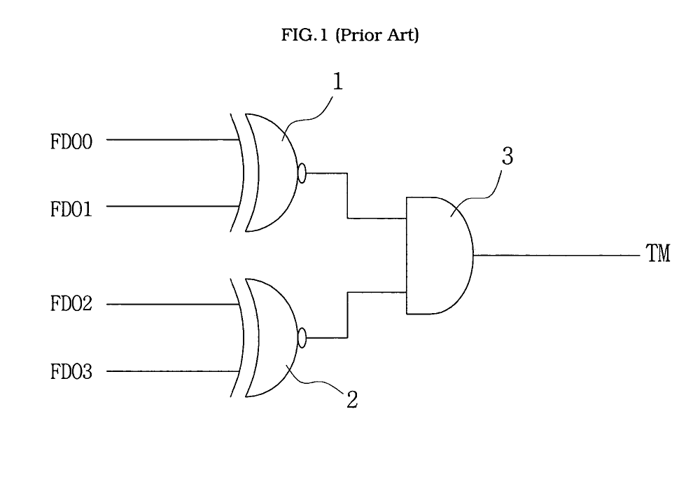

### DETAILED DESCRIPTION OF EXAMPLE EMBODIMENTS OF THE INVENTION

Hereinafter, example embodiments of the present invention will be described in detail with reference to the accompanying drawings. The same reference numerals are used to denote the same elements throughout the drawings.

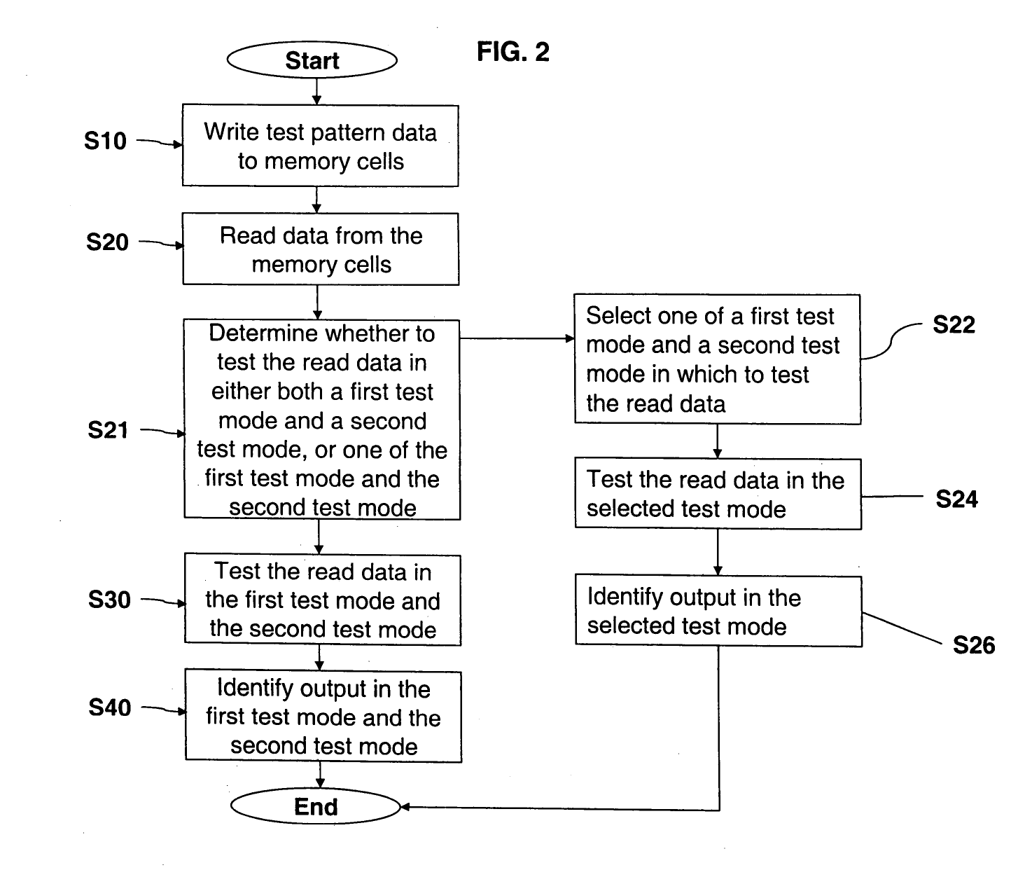

FIG. 2 illustrates a flowchart of a parallel bit test method for a semiconductor memory device according to an exemplary embodiment of the present invention. In S10, test pattern data may be written to each of a plurality of memory cells of the semiconductor memory device. In S20, a read operation may be performed on each of the plurality of memory cells in the semiconductor memory device.

In S21, it is determined whether to test the read data in either both a first test mode and a second test mode, or one of the first test mode and the second test mode. The determination in S21 may be based on performance and/or other testing parameters.

The process may advance to S30 when it is determined to test the read data in both the first test mode and the second test mode. In S30, the read data from the plurality of memory cells may be tested in a first test mode and a second test mode. In an exemplary embodiment of the present invention, in the first test mode, the read data from the plurality of memory cells may be input in pairs of data sets. For each of the pairs of data sets it may be determined which of the pairs of data sets are complementary and which of the pairs of data sets are not complementary.

In an exemplary embodiment of the present invention, in the second test mode, the read data from the plurality of memory cells may be input in pairs of data sets and for each of the pairs of data sets it may be determined which of the pairs of data sets are identical and which of the pairs of data sets are not identical.

In an exemplary embodiment of the present invention, in the first test mode, a first logic level signal (for example, a high logic level signal) may be output when two data sets in at least one of the pairs of data sets are complementary.

In an exemplary embodiment of the present invention, in the second test mode, a second logic level signal (for example, a low logic level signal) may be output when two data sets in at least one of the pairs of data sets are identical.

In S40, a first test mode output and a second test mode output may be identified. The first test mode output may be identified by comparing the first test mode output with a first test signal. The second test mode output may be identified by comparing the second test mode output with a second test signal. It may then determined whether the read data of at least one of the plurality of memory cells is inverted.

In another exemplary embodiment of the present invention, the process illustrated in FIG. 2 may proceed to S22 after S21 instead of S30 when it is determined to test the read data in one of the first test mode and the second test mode. In S22, a selection is made of whether to test the read data in one of either the first test mode or the second test mode. The selection may be based on the performance of the first test mode and/or the second test mode, and/or for other reasons.

In an exemplary embodiment of the present invention, the selection of the first or the second test mode may be determined based on a mode register set (MRS) signal. An example of how the MRS signal may select between the first test mode and the second test mode will now be described. The MRS signal may determine parameters. These parameters may include a column access strobe (CAS) latency, burst type, burst length, and/or other parameters. The MRS signal may control the operating modes of a semiconductor memory device with the determination of the parameters. The MRS signal may control the parameters of test modes for a semiconductor memory device. The MRS signal may therefore select between either the first test mode and the second test mode without using an additional control signal.

Read data from the plurality of memory cells will now be described with reference to Table 1. Table 1 illustrates an example truth table of output signals in a parallel bit test mode using four test data signals according to an exemplary embodiment of the present invention.

TABLE 1

| | | | | | First test | |
|---|---|---|---|---|---|---|
| Test data | | | | | mode | Second test |
| format | D0 | D1 | D2 | D3 | output | mode output |
| #0 | 0 | 0 | 0 | 0 | 0 | 1 |
| #3 | 0 | 0 | 1 | 1 | 0 | 1 |
| #C | 1 | 1 | 0 | 0 | 0 | 1 |
| #F | 1 | 1 | 1 | 1 | 0 | 1 |
| #1 | 0 | 0 | 0 | 1 | 1 | 1 |
| #2 | 0 | 0 | 1 | 0 | 1 | 1 |
| #4 | 0 | 1 | 0 | 0 | 1 | 1 |
| #8 | 1 | 0 | 0 | 0 | 1 | 1 |
| #E | 1 | 1 | 1 | 0 | 1 | 1 |
| #D | 1 | 1 | 0 | 1 | 1 | 1 |
| #B | 1 | 0 | 1 | 1 | 1 | 1 |
| #7 | 0 | 1 | 1 | 1 | 1 | 1 |
| #5 | 0 | 1 | 0 | 1 | 1 | 0 |
| #A | 1 | 0 | 1 | 0 | 1 | 0 |
| #6 | 0 | 1 | 1 | 0 | 1 | 0 |
| #9 | 1 | 0 | 0 | 1 | 1 | 0 |

In Table 1, a binary unit “1” represents data at the first logic level, and a binary unit “0” represents data at the second logic level. It may be assumed that D0, D1, D2 and D3, respectively, may represent a 4-bit binary number. Therefore, [D0, D1, D2, D3] may correspond to [0,0,1,0] which may represent a test data format #3, and [1,1,0,0] may represent a test data format of “#12”, or “#C” in hexadecimal notation. The test data formats shown in Table 1 have been converted to hexadecimal notation. Table 1 illustrates first test mode output and second test mode output, which may be based on the four test data signals D0, D1, D2 and D3.

In an exemplary embodiment of the present invention, the read data of each of the plurality of memory cells may be determined to be inverted. In the first test mode, the first test mode output may be set to the first logic level, or “1”. In the second test mode, the second test mode output may be set to a low logic level, or “0”. Referring to Table 1, test data formats #5, #A, #6, and #9 may have the first test mode output set to 1 and the second test mode output set to 0. Therefore, the test data formats #5, #A, #6 and #9 may be suitable for testing the read data of the plurality of memory cells for inversion.

An exemplary embodiment of the present invention for detecting a failure of a memory cell will now be described with reference to an example using the test data format #5 as illustrated in Table 1. According to test data format #5, D0 is at the second logic level, D1 at is the first logic level, D2 is at the second logic level and D3 is the first logic level. The four test data D0-D3 may be written to the four memory cells. A read operation may then be executed on each of the four memory cells. The outputs FD00-FD03 of the four memory cells, may correspond to test data signals D0-D3, respectively. The outputs FD00-FD03 may be tested in the first test mode and/or the second test mode, respectively.

When FD00-FD03 each have the second logic level signal, it may be understood that failures may have occurred in two of the four memory cells. In this case, the first test mode output may be set to the second logic level signal, and the second test mode output may be set to the first logic level signal. However, when the test data D0-D3 is tested in the first test mode, the first test mode output may be set to the first logic level signal. Further, when the test data D0-D3 are tested in the second test mode, the second test mode output may be set to the second logic level signal. Accordingly, when test data D0-D3 are compared with the first test mode output and/or the second test mode output, it may be inferred that two of the test data D0-D3 may have been inverted in FD00-FD03.

In another exemplary embodiment of the present invention, when FD00-FD03, configured to conform with test data format #5, have logic levels low, high, low, and low, respectively, due to a failure occurring in one of the four memory cells, both the first test mode output and the second test mode output may be set to the first logic level signal. It should be understood that both the first test mode and the second test mode may be required to detect an inversion in one of the four memory cells according to this example.

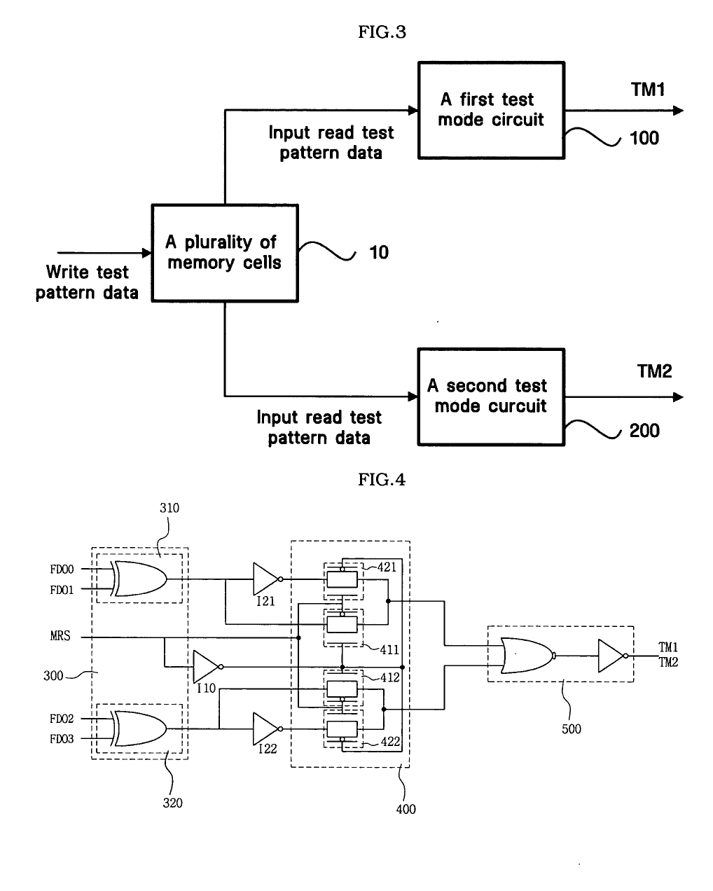

FIG. 3 illustrates a block diagram of a parallel bit test circuit of a semiconductor memory device according to an exemplary embodiment of the present invention. Referring to FIG. 3, the parallel bit test circuit according to the present invention may include a first test mode circuit 100 and a second test mode circuit 200.

In an exemplary embodiment of the present invention, test pattern data is initially written to a plurality of memory cells. The first test mode circuit 100 may receive data from the plurality of memory cells 10 in pairs, wherein a pair may comprise two data sets. The first test mode circuit 100 may detect whether the two data sets in at least one pair are complementary. The second test mode circuit 200 may receive data from the plurality of memory cells 10 in pairs, wherein a pair may comprise two data sets. The second test mode circuit 200 may detect whether the two data sets in at least one pair are identical. In this way, data written to the plurality of memory cells 10 may be read and output to the first test mode circuit 100 and the second test mode circuit 200.

In an exemplary embodiment of the present invention, if the two data sets in at least one pair received by the first test mode circuit 100 are complementary, an output signal TM1 of the first test mode circuit 100 may be set to the first logic level signal.

In an exemplary embodiment of the present invention, if the two data sets in at least one pair received by the second test mode circuit 200 are identical, an output signal TM2 of the second test mode circuit 200 may be set to the first logic level signal.

In an exemplary embodiment of the present invention, data from the plurality of memory cells may be output to the first test mode circuit 100 and/or the second test mode circuits 200 such that output signal TM1 may be set to the first logic level signal and output signal TM2 may be set to the second logic level signal.

In another exemplary embodiment of the present invention, the first test mode circuit 100 may include a plurality of exclusive OR gates to which the data from the plurality of memory cells 10 may be input in pairs of data sets, and/or an OR gate which may receive output signals from the plurality of exclusive OR gates as inputs. In another exemplary embodiment of the present invention, the second test mode circuit 200 may include the plurality of exclusive OR gates to which the data from the plurality of memory cells 10 may be input in pairs of data sets, and/or an OR gate which may receive inverted signals from the plurality of exclusive OR gates as inputs.

FIG. 4 illustrates a parallel bit test circuit of a semiconductor memory device in another example embodiment. The parallel bit test circuit may include a first comparator 300, a test mode selector 400, and/or a second comparator 500.

In another exemplary embodiment of the present invention, the parallel bit test circuit of a semiconductor memory device shown in FIG. 3 may be implemented by a circuit as illustrated in FIG. 4.

Referring to FIG. 4, the first comparator 300 may include a plurality of first comparison circuits 310 and 320. Each of the first comparison circuits 310 and 320 may receive data sets FD00-FD03 from the plurality of memory cells 10. The first comparison circuits 310 and 320 may output first logic level signals when two data sets received in pairs are complementary. For example, when FD00 and FD01 are complementary, first comparison circuit 310 may output a first logic level signal. Further, when FD02 and FD03 are complementary, first comparison circuit 320 may output the first logic level signal. Each of the first comparison circuits 310 and 320 may be implemented as an exclusive OR gate, as illustrated in FIG. 4.

In an exemplary embodiment of the present invention, the test mode selector 400 may select between the output of the first comparison unit 310 and the inverted output of the first comparison 310, which may be inverted through inverter 121. The test mode selector may also select between the output of the first comparison unit 320 and the inverted output of the first comparison unit 320, which may be inverted through inverter 122. The selected signals may be output to the second comparator 500. The test mode selector 400 may be implemented with transmission gates 411, 412, 421, and 422, as illustrated in FIG. 4.

In another exemplary embodiment of the present invention, the test mode selector 400 may execute the selection in response to an MRS signal. Thus, the first and the second test modes may be selected for performing the test without using a control signal other than the MRS signal. This may include the inverted MRS signal, which may be inverted through inverter 110.

In an exemplary embodiment of the present invention, the second comparator 500 may perform an OR operation on the selected outputs from the test mode selector 400. The output of the second comparator 500 may be a first test mode output signal TM1 and/or a second test mode output signal TM2. The second comparator 500 may output the first test mode output TM1 when the test mode selector 400 selects the first test mode input signals. The second comparator 500 may output the second test mode output TM2 when the test mode selector selects the first test mode input signals. The second comparator 500 may be implemented with an OR gate, as illustrated in FIG. 4.

In an exemplary embodiment of the present invention, the second comparator 500 may output the first logic level signal when the test mode selector 400 selects first test mode input and the second comparator 500 may output a second logic level signal when the test mode selector 400 selects second test mode input.

Operations of the parallel bit test circuit according to another exemplary embodiment of the present invention will now be described in detail with reference to FIG. 4. Test data D0-D3 may be written to four memory cells, respectively. The contents of the four memory cells may then be output as data signals FD00-FD03. Data signals FD00-FD03 may be paired, and a pair may be output to each of the first comparison circuits 310 and 320, respectively.

When the MRS signal is at the second logic level, the transmission gates 411 and 412 may be enabled and may transmit the output signals of the first comparison circuits 310 and 320 to the second comparator 500 as the first test mode input signals. The second comparator 500 may perform an OR operation on the first test mode input signals transmitted from the transmission gates 411 and 412, and the OR operation may output the first test mode output signal TM1.

When the MRS signal is at the first logic level signal, the transmission gates 421 and 422 may be enabled and may transmit inverted signals of the output signals of the first comparison circuits 310 and 320 to the second comparator 500 as the second test mode input signals. The second comparator 500 may perform an OR operation on the second test mode input signals transmitted from the transmission gates 421 and 422, and the OR operation may output the first test mode output signal TM2.

In another exemplary embodiment of the present invention, the parallel bit test circuit may include the test mode selector 400 and may use the output signals of the first comparison circuits 310 and 320 as the first test mode input signals and the inverted signals of the output signals of the first comparison circuits 310 and 320 as the second test mode input signals. Therefore, a test may be performed in both the first test mode and the second test mode. Further, both the first test mode output signal TM1 and the second test mode output signal TM2 may be obtained from a single OR gate. As a result, when a parallel bit test is implemented on a semiconductor substrate, the area of the semiconductor may be reduced as compared to parallel bit test circuits by conventional methods.

The exemplary embodiments of the present invention being thus described, it will be obvious that the same may be varied in many ways. For example, additional test modes may be implemented similar to the first and second test modes. Further, circuits for a parallel bit test of a semiconductor device according to exemplary embodiments of the present invention are not limited to testing for memory cells, but rather may test any number of memory cells. Further, the semiconductor device test may be applied at a wafer level and/or a package level according to exemplary embodiments of the present invention.

Such variations are not to be regarded as departure from the spirit and scope of the exemplary embodiments of the present invention, and all such modifications as would be obvious to one skilled in the art are intended to be included within the scope of the following claims.

1. A method for performing a parallel bit test of a semiconductor memory device, comprising:
writing data to each of a plurality of memory cells;
reading data from each of the plurality of memory cells;
testing the data from each of the plurality of memory cells in a first test mode; and
testing the data from each of the plurality of memory cells in a second test mode.

2. The method of claim 1, wherein the data from the plurality of memory cells is output in pairs of data sets.

3. The method of claim 2, wherein the first test mode detects whether data sets in at least one pair are complementary.

4. The method of claim 2, wherein the second test mode detects whether data sets in at least on pair are identical.

5. The method of claim 1, further comprising:
generating a first test mode output; and
generating a second test mode output.

6. The method of claim 5, further comprising:
comparing the first test mode output with a first signal; and
comparing the second test mode output with a second signal.

7. The method of claim 1, further comprising selecting one of the first test mode and the second test mode in which to test the data.

8. The method of claim 7, wherein the selection is based on a mode register set signal.

9. The method of claim 1, further comprising generating a first logic level signal when the data is tested in a first test mode.

10. The method of claim 9, further comprising generating a second logic level signal when the data is tested in a second test mode.

11. A circuit, comprising:
a first test mode circuit for receiving first data;
a second test mode circuit for receiving second data;
wherein the first test mode circuit tests the received first data and the second test mode tests the received second data.

12. The circuit of claim 11, wherein the first data is comprised of at least one pair of data sets.

13. The circuit of claim 11, wherein the second data is comprised of at least one pair of data sets.

14. The circuit of claim 12, wherein the first test mode circuit tests the first data to determine whether the at least one pair of data sets is complementary.

15. The circuit of claim 13, wherein the second test mode circuit tests the second data to determine whether at least one pair of data sets is identical.

16. The circuit of claim 11, wherein the first test mode circuit outputs a first logic level signal when receiving the first data.

17. The circuit of claim 16, wherein the second test mode circuit outputs a second logic level signal when receiving the second data.

18. A circuit, comprising:
a first comparator including a plurality of comparison circuits;
a test mode selector for selecting at least one of a plurality of outputs from the first comparator; and
a second comparator for receiving the selected output.

19. The circuit of claim 18, wherein each comparison circuit receives a pair of data sets.

20. The circuit of claim 19, wherein each comparison circuit outputs a first logic level signal when the received pair of data sets is complementary.

21. The circuit of claim 18, wherein the test mode selector selects at least one of the plurality of outputs as at least one of a first test mode input signal and a second test mode input signal.

22. The circuit of claim 21, wherein:
the second comparator performs an OR operation on the first test mode input signals; and
the second comparator outputs the result of the OR operation.

23. The circuit of claim 21, wherein:
the second comparator performs an OR operation on the second test mode input signals; and
the second comparator outputs the result of the OR operation.

24. The circuit of claim 18, wherein the test mode selector selects the at least one of the plurality of outputs from the first comparator based on a mode register set signal.

25. The circuit of claim 21, wherein the second comparator outputs a first logic level signal when receiving the selected at least one of the plurality of outputs from the first comparator as first test mode input signals.

26. The circuit of claim 25, wherein the second comparator outputs a second logic level signal when receiving the selected at least one of the plurality of outputs from the first comparator as second test mode input signals.

27. A method for performing a parallel bit test of a semiconductor memory device, using the circuit of claim 11.

28. A method for performing a parallel bit test of a semiconductor memory device, using the circuit of claim 18.
